(19) United States
(12) Patent Application Publication
(10) Pub. No.: US 2015/0153212 A1
(43) Pub. Date: Jun. 4, 2015

(54) FUEL SURFACE HEIGHT MEASUREMENT

(71) Applicant: AIRBUS OPERATIONS LIMITED, BRISTOL (GB)

(72) Inventors: Alessio CIPULLO, BRISTOL (GB); Franklin TICHBORNE, BRISTOL (GB); Joseph K-W LAM, BRISTOL (GB); Timothy LEIGH, BRISTOL (GB)

(21) Appl. No.: 14/555,818

(22) Filed: Nov. 28, 2014

(30) Foreign Application Priority Data
Nov. 29, 2013 (GB) 1321047.1

(51) Int. Cl. G01F 23/292; G06K 9/52; G01F 23/00

(52) U.S. Cl. CPC G01F 23/292; G01F 23/0061; G06K 9/52

(57) ABSTRACT

A method of measuring a height of a fuel surface of fuel in an aircraft fuel tank. One or more images of the fuel surface are captured, each image including a fuel surface line where the fuel surface meets a structure. Each image is analysed in order to determine a height of the fuel surface line at three or more points in the image. If the fuel surface line is not a straight line, then an average angle of the fuel surface line can be determined from the points in the image by spatial averaging. Preferably a series of images of the fuel surface are captured over a time period, and an average height of the fuel surface is determined from the series of images by time averaging. The height of the fuel surface line(s) at three or more points is used to determine a volume of the fuel, a mass of the fuel, and/or an attitude of the fuel surface.

### FIELD OF THE INVENTION

The present invention relates to a method and apparatus for measuring a height of a fuel surface in an aircraft fuel tank.

### BACKGROUND OF THE INVENTION

A known method of measuring a height of a fuel surface in an aircraft fuel tank is described in U.S. Pat. No. 6,782,122. The liquid surface is illuminated with a light pattern of three spots, and a camera captures an image of the light pattern. Since the camera is at a known location, the area and shape of the triangle formed by the three spots may be used to infer the height and attitude of the fuel surface, using a look-up table or neural network, for example.

### SUMMARY OF THE INVENTION

A first aspect of the invention provides a method of measuring a height of fuel surface of fuel in an aircraft fuel tank, the method comprising: capturing one or more images of the fuel surface, each image including a fuel surface line where the fuel surface meets a structure; and analysing the (or each) image in order to determine a height of the fuel surface line at three or more points in the image. At least one of the fuel surface lines is not straight, and an average angle of that fuel surface line is determined from the points in the image by spatial averaging.

A second aspect of the invention provides apparatus for measuring a height of a fuel surface in an aircraft fuel tank, the method comprising: an image capture device arranged to capture one or more images of the fuel surface, each image including a fuel surface line where the fuel surface meets a structure; and a processor arranged to analyse the (or each) image in order to determine a height of the fuel surface line at three or more points in the image. At least one of the fuel surface lines is not straight, and the processor is arranged to determine an average angle of that fuel surface line from the points in the image by spatial averaging.

A third aspect of the invention provides an aircraft fuel tank system comprising a fuel tank, and apparatus according to the second aspect for measuring a height of a fuel surface in the fuel tank.

The inventor has identified a number of previously unidentified problems with the method U.S. Pat. No. 6,782,122. Firstly, slosh of the fuel may cause the triangle of spots to form an unpredictable shape which cannot be used to accurately infer the height and attitude of the fuel surface. Secondly, foaming of the fuel surface might significantly affect accuracy, as the illumination light can be scattered. Thirdly, the presence of structural elements, such as fuel pipes or pumps, might interfere with the light pattern and affect the accuracy. Fourthly, tank vibrations can induce significant shaking on the light pattern which will in turn affect measurement accuracy. The present invention provides at least a partial solution to one or more of these problems.

Typically each image is analysed by determining a height of the fuel surface line at three or more, ten or more, or one hundred or more points in the image. If a fuel surface line is not a straight line, then an average angle of that fuel surface line can then be determined from the points in the image by spatial averaging.

Preferably a series of images of the fuel surface are captured over a time period, and an average height of the fuel surface is determined from the series of images by time averaging. The length of the time period may be greater than one minute (for instance five to ten minutes) or less than ten seconds (for instance 5-10 seconds). The length of the time period may change based on an operational state of the aircraft: for instance it may be greater than one minute during manoeuvring of the aircraft, or less than ten seconds during refuel of the aircraft.

The invention may simply determine the height of the fuel surface without any further analysis, but more typically the height of the fuel surface line(s) at three or more points is used to determine a volume of the fuel, a mass of the fuel, and/or an attitude of the fuel surface. The small size of the pattern in U.S. Pat. No. 6,782,122 relative to the total area of the fuel surface means that the distance between the three points is small and as a result the measurement can lack accuracy. By taking the data points from the fuel surface where meets the structure (typically at a peripheral edge of the fuel surface) the present invention enables the points to be more widely spaced apart than in U.S. Pat. No. 6,782,122.

If the precise position and viewing angle of the image capture device is known, then the height of the fuel surface line can be determined simply by determining its position in the image without requiring a reference to any other features in the image. However more typically each image is analysed by determining a height of the fuel surface line at three or more points in the image relative to a reference feature in the image, for instance by counting pixels between the line and the feature. The feature in the image may be any feature in the fuel tank such as a bracket, stringer etc. but more preferably the feature in the image is a grid line (typically a horizontal grid line) carried by the structure (for instance painted or otherwise formed on the structure).

The image capture device typically comprises a fiberscope comprising a bundle of optical fibres. A lens may be provided at one end of the bundle, and an eyepiece at another end of the bundle.

The image capture device may be inside the fuel tank, but more preferably the fuel tank comprises a window, and the image capture device is positioned outside the fuel tank and arranged to capture the image(s) of the fuel surface through the window.

A process of distortion correction may be applied to the image.

The apparatus typically comprises a light source for illuminating the fuel surface during capture of the image(s).

The image(s) may be acquired from visible light, or from non-visible radiation such as infra-red radiation.

A display device may be arranged to receive and display at least one of the images, for instance to a pilot or ground crew.

### BRIEF DESCRIPTION OF THE DRAWINGS

Embodiments of the invention will now be described with reference to the accompanying drawings, in which:

FIG. 1 is a schematic view of apparatus for measuring a height of a fuel surface in an aircraft fuel tank,

FIG. 2 shows painted grid lines and numbers on the walls of the fuel tank;

FIG. 3 shows the problem of image distortion;

FIG. 4 is a simplified 2D view of an image of a wall of the fuel tank;

FIG. 5 is a simplified 2D view of an image of a wall of the fuel tank showing the fuel surface at an angle;

FIG. 6 shows a fuel tank with three measured points for the fuel surface;

FIG. 7 shows the fuel tank of FIG. 6 with further labelling;

FIG. 8 shows a fuel tank with a non-planar fuel surface;

FIG. 9 is a simplified 2D view of an image of a wall of the fuel tank of FIG. 8;

FIG. 10 shows a series of two measurements;

FIG. 11 shows a centralised architecture for a measurement system on an aircraft; and

FIG. 12 shows a localised architecture for a measurement system on an aircraft.

### DETAILED DESCRIPTION OF EMBODIMENT(S)

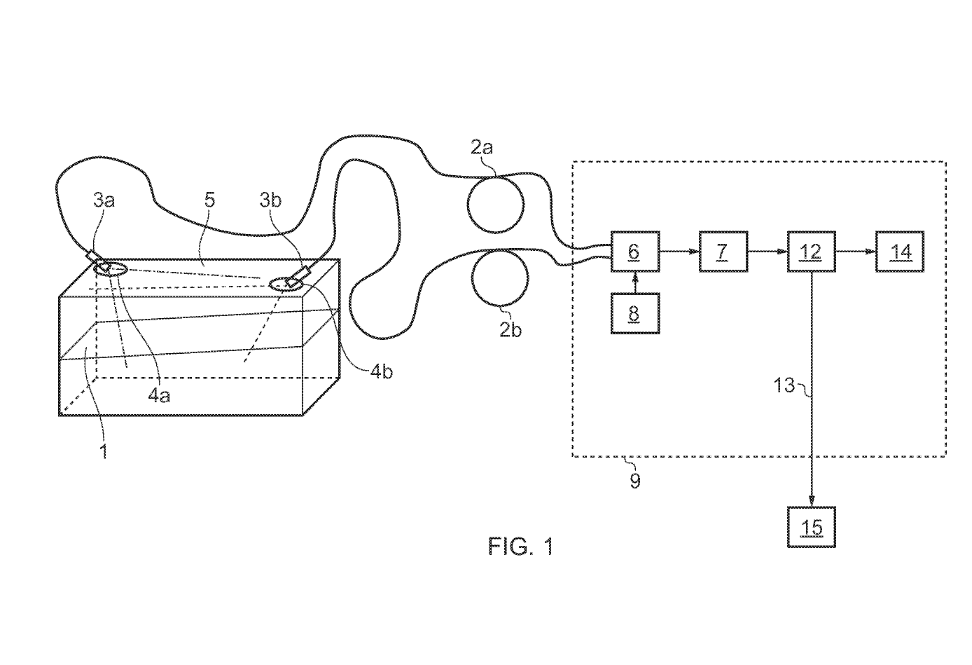

FIG. 1 is a schematic view of an aircraft fuel tank system comprising a fuel tank, and apparatus for measuring a height of a fuel surface 1 of fuel in the fuel tank. A pair of fiberscopes are arranged to capture images of the fuel surface. Each fiberscope comprises a bundle of optical fibres 2a,b and an imaging lens 3a,b. Potentially thousands of fibres can be provided in each bundle, and each bundle can have a length of the order of 100 m. The resolution of the image is essentially determined by the number of optical fibres, and the optimal number of fibres can be selected to give the required resolution and accuracy.

The lenses 3a,b can view into the fuel tank through respective optical access windows 4a,b located at opposite ends of a top wall 5 of the fuel tank, in a position where the wall 5 is not normally covered in fuel. The windows 4a,b have hydrophobic coatings to minimise problems with condensation, fog, frost and microbial growth. The bundles 2a,b lead to an eyepiece 6 at their other end, which is coupled in turn to a digital camera 7 which can acquire and digitise images of the field of the view of the lenses 3a,b. The interior of the fuel tank is illuminated by a light source 8 (such as a light emitting diode) mounted close to the eyepiece. Light from the light source is routed into the tank through part of the bundles of optical fibres 2a,b.

Although two fiberscopes and two windows are shown in the embodiment of FIG. 1, optionally there may be only a single fiberscope/window, or more fiberscopes/windows (three, four etc.). Also, optionally the fiberscopes may be omitted, and digital cameras placed on the windows to directly acquire the images.

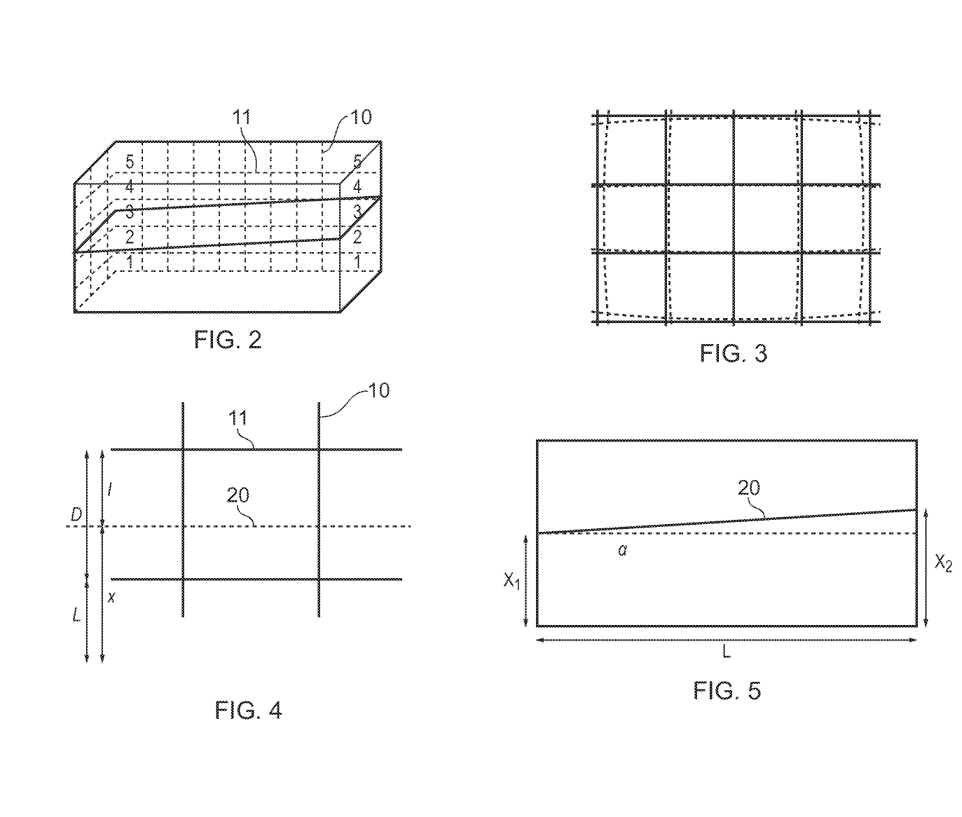

The fuel tank is shown schematically with a parallelepiped structure with front and rear walls, left and right side walls, a bottom wall and a top wall. The interior faces of at least two adjacent ones of the walls are painted with a structure of vertical grid lines 10 and horizontal grid lines 11 shown in FIG. 2. Optionally the interior faces of the walls are also painted with numbers as shown in FIG. 2 (in this case the numbers one to five).

Each lens 3a,b is pointed towards a respective corner of the fuel tank, with a large field of view. This wide angle of view creates image distortion illustrated in FIG. 3, which shows the orthogonal straight grid lines 10, 11 in solid lines, and the distorted image of these grid lines in broken lines. An image elaboration (correction) processor 12 shown in FIG. 1 applies a predetermined correction coefficient matrix to the images in order to correct for this distortion. The grid lines 10, 11 assist in this correction process.

The corrected images can then be output on an output line 13 to a display device 15 for display to a pilot of the aircraft during flight of the aircraft, or to ground crew during refuel and ground operations. The painted numbers in the images enable the pilot or ground crew to obtain a crude estimation of the height of the fuel, and then determine the fuel volume with reference to a look-up table. The pilot or ground crew can also use the image to check for debris on the fuel surface.

The camera may be an optical camera, or a thermal camera which could be used to check temperature distribution of the components of the fuel system (for instance fuel pumps) as well as being used to provide images for determination of fuel level (as described herein).

A more accurate estimation of the fuel surface height (along with the attitude, volume and mass of the fuel) is determined by a processor 14. The algorithm used by the processor 14 will now be described with reference to FIGS. 4 to 9.

FIG. 4 is a simplified 2D view of an image of a wall of the fuel tank, assuming for simplicity the fuel surface to be horizontal and planar. The image includes a fuel surface line 20 where the fuel surface 1 meets the wall. The liquid level x from the bottom of the tank is measured by counting the number of pixels between a suitable horizontal line 11 of the painted grid (preferably above the fuel level) and the liquid level itself. Therefore, the accuracy depends on the number of pixels along the vertical axis contained in a grid box and it can expressed as:

$$Δ {x}_{instr} = \frac{D}{{N}_{pix \_ D}} \qquad Eq . 1$$

Where x is the distance from the fuel surface line 20 to the bottom wall of the tank, Δxᵢₙₛₜᵣ is the instrumental resolution related to the height measurement, D is the distance between horizontal grid lines 11 and Nₚᵢₓ_{_{—}}_{D} is the number of pixels on the acquired image corresponding to the distance D shown in FIG. 4. If the tank height is 1 m and 1000 pixels are available for the vertical axis of the image captured by the camera, the instrumental resolution is ±1 mm. Assuming that all the errors connected to the fibre bundle resolution, electronics, and image acquisition & conditioning are within the instrumental resolution, Δxᵢₙₛₜᵣ is equal to the instrumental error. The total error is given by taking into account the statistical error. The statistical error can be minimised by taking several images and averaging the results from them:

Δxₜₒₜ=\sqrt{Δxᵢₙₛₜᵣ²+Δxₛₜₐₜ²} Eq. 2

Image elaboration is based on the binarisation of the image using a predefined threshold. The image is converted from colour/grey scale to B/W using a threshold to decide if a pixel previously coloured will become black or white. This can be achieved by one of the predefined Matlab functions, like img2bw (http://www.mathworks.fr/fr/help/images/ref/im2bw.html). If the contrast of the image is adjusted properly, the interface between the fuel and the tank can be visualised as a transition between white and black pixels (or vice versa) and using the reference grid 10, 11 it is possible to precisely locate the fuel surface on the tank wall.

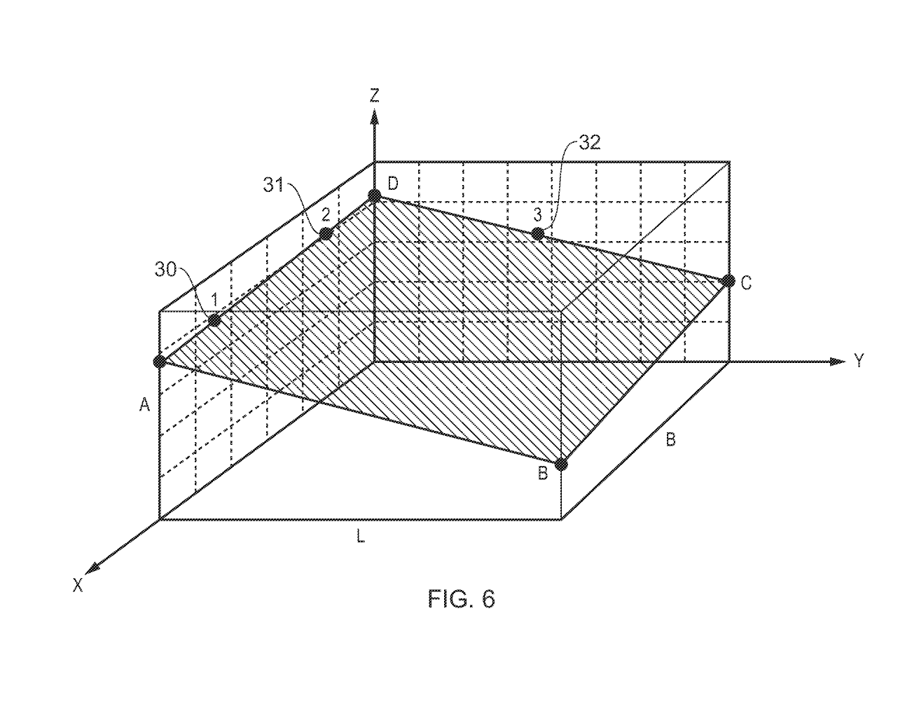

FIG. 5 is a simplified 2D view of an image of the front wall of the fuel tank, assuming for simplicity the pitch angle of the aircraft to be 0°. As with FIG. 4, the image includes a fuel surface line 20 where the fuel surface 1 meets the front wall, but this time the fuel surface is not assumed to be horizontal. The fuel surface line 20 has a height x₁ at its left end and a height x₂ at its right end. Once these heights x₁, x₂ have been determined by the processor 14, the roll angle of the fuel surface 1 (and hence the aircraft) can be determined by the following relation:

$$α = {tan}^{- 1} ( \frac{{x}_{2} - {x}_{1}}{L} ) \qquad Eq . 3$$

Where α is the roll angle and the other parameters are defined in FIG. 5.

Propagating the error on Eq. 3, the result is described by Eq. 4:

$$Δ {α}_{instr} = \sqrt{2 {( \frac{1}{1 + {( \frac{{x}_{2} - {x}_{1}}{L} )}^{2}} )}^{2} Δ {x}_{instr}^{2}} \qquad Eq . 4$$

Taking into account the statistical error, the total error is:

Δαₜₒₜ=\sqrt{Δαᵢₙₛₜᵣ²+Δαₛₜₐₜ²} Eq. 5

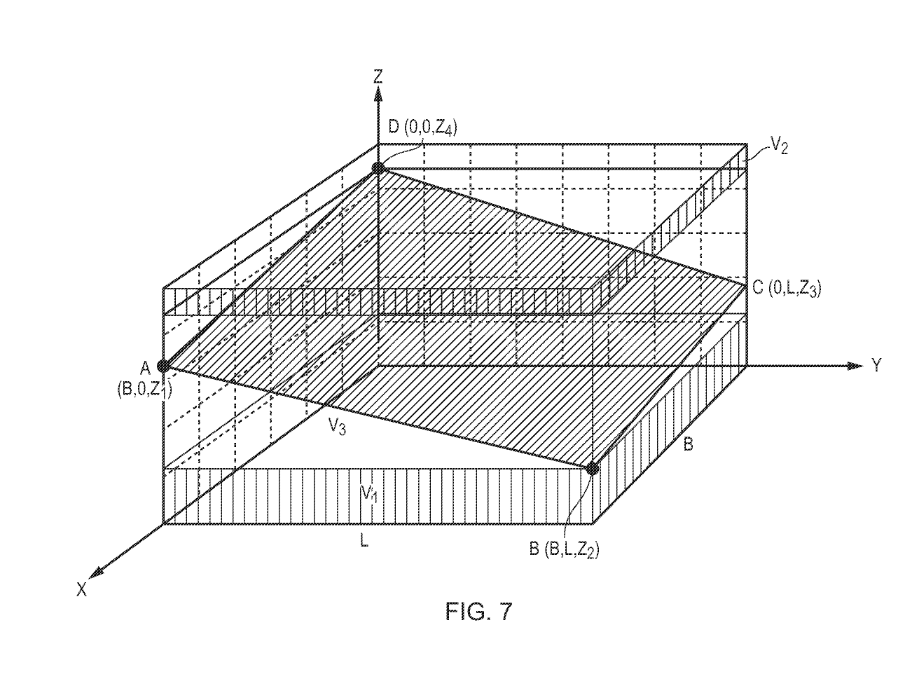

FIG. 6 shows a parallelepiped fuel tank with a fuel surface which meets the corners of the tank at four points A-D. A height of the fuel surface is determined at three non-collinear points 30-32. From these three data points it is possible to calculate the height at the four corners A-D. FIG. 7 shows the same fuel tank with further labels added, where V₁ is the volume below the lowest point B; V₂ is the volume above the highest point D; and V₃ is the volume between points B and D. For a parallelepiped tank, these volumes can be calculated from the known heights Z₁, Z₂, Z₃, Z₄ of the points A-D, and the fuel volume for the fuel tank shown in FIG. 7 can then be computed by adding volume V₁ to the portion of the volume V₃ underneath the fuel surface identified by points A-D. If the fuel surface is parallel to the bottom wall (the x-y plane in FIG. 7), V₃ is equal to zero.

Thus from three data points 30-32 the processor 14 can infer the height and attitude of the fuel surface, and the volume of fuel in the fuel tank. Knowing the density of the fuel, it is therefore also possible to determine its mass.

A similar process can be used by the processor 14 to determine the volume/mass of fuel in a fuel tank which is not a parallelel piped, as long as the geometry of the tank is known. In such a case the volume/mass of fuel can be determined from the heights of the three points 30-32, based on a look-up table, a neural network, or a computer model of the tank geometry.

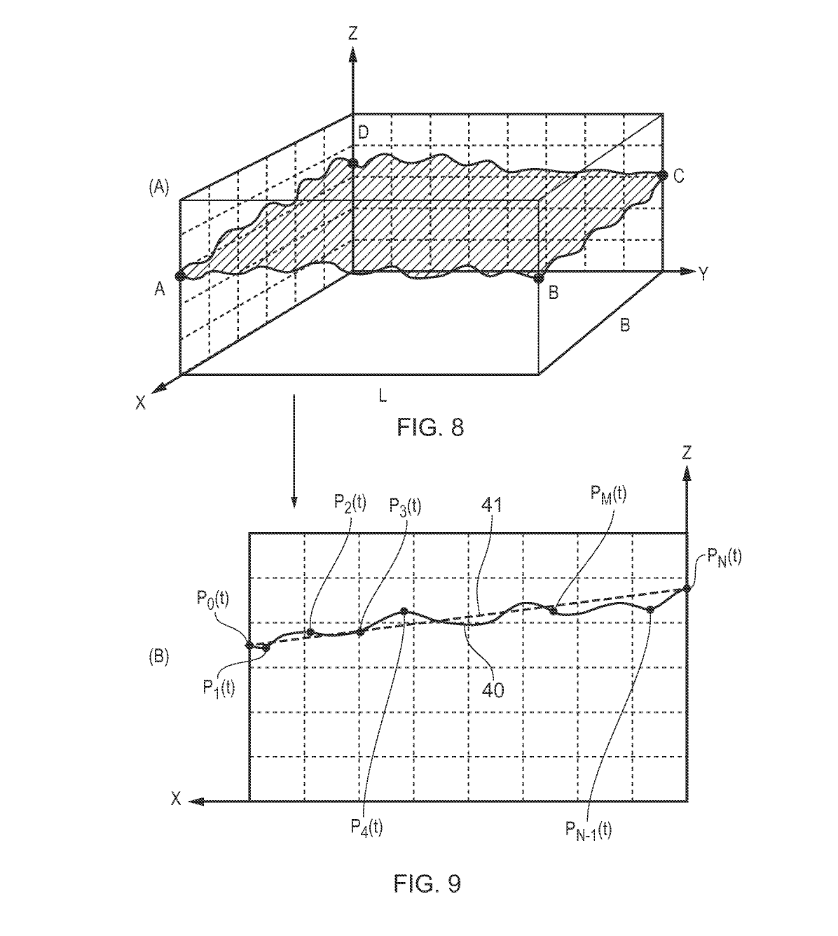

FIG. 8 shows a parallelepiped fuel tank with a fuel surface which meets the corners of the tank at four points A-D, with fuel slosh causing the fuel surface to be non-planar. FIG. 9 shows an image of one of the walls of the tank including a non-linear fuel surface line 40. At any given time to when an image is captured, a series of points P₀(t₀) to P_{N}(t₀) on the non-linear line 40 can be used to identify a linear line 41 by spatial averaging, for instance by using a linear regression technique such as a classical least-squares approach. The number of points N+1 is flexible and can be selected to optimise the accuracy of the linear regression technique without excessive computational effort. The optimum value for N+1 depends on the horizontal resolution of the camera. N+1 should preferably not be lower than 1/10 of the number of pixels along the horizontal axis of the camera. For instance, if the number of pixels along the horizontal axis of the camera is 1000, N+1 should be at least 100.

Moreover, as the shape of the fuel surface will change over time, at a time t₁ a new set of points P₀(t₁) to P_{N}(t₁) is available and a new linear line 41 can be identified. The linear function for tₖ can be written as:

z=m(tₖ)x+c(tₖ) Eq. 6

where m(tₖ) is the slope of the linear function at tₖ and c(tₖ) is the intercept. The linear fuel edge 41 can also be averaged in time:

$$\begin{matrix}z = mx + c \\ with & Eq . 7 \\ m = \frac{1}{M} {\sum }_{k = 1}^{M} m ( {t}_{k} ) \\ and & Eq . 8 \\ c = \frac{1}{M} {\sum }_{k = 1}^{M} c ( {t}_{k} ) & Eq . 9\end{matrix}$$

where M is the number of acquired images used for the time averaging. The time period of the averaging, and hence M, will depend on the operational condition of the aircraft. During manoeuvres (e.g. taxi, take-off and flight) the time period could be 5 to 10 minutes for example. When the aircraft is not manoeuvring (e.g. during refuel) the time period could be 5 to 10 s for example.

The same approach can be applied on the other walls of the fuel tank. Finally, the two averaging techniques described above (spatial averaging and time averaging) can be combined to filter out the effect of fuel slosh and provide higher accuracy.

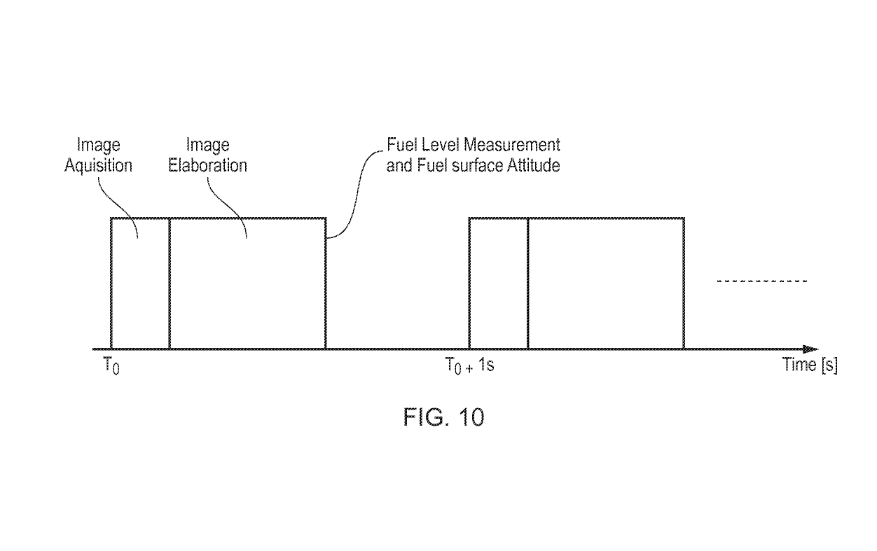

The image acquisition and elaboration must be performed in real-time to allow a refresh time of the fuel quantity indication of 1 s (1 Hz refresh rate) as illustrated in FIG. 10. To allow this, a Digital Signal Processor (DSP) or similar high performance processors might be used for elements 7, 12 and 14 in FIG. 1.

FIG. 10 shows two measurements spaced apart by 1 s. Optionally the two fiberscopes may be operated alternately (rather than simultaneously) so they are not “blinded” by light from the other fiberscope.

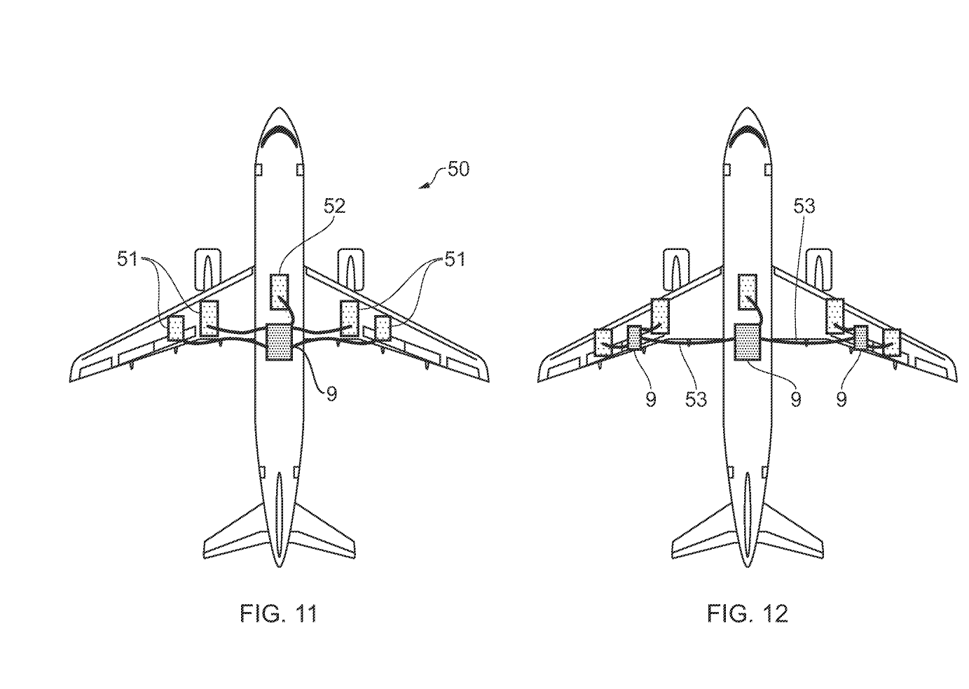

FIG. 11 is a plan view of an aircraft 50 incorporating the system of FIG. 1. The aircraft has a wing fuel tank in each wing, and a centre fuel tank under the fuselage. Each fuel tank is divided into a number of bays, each bay being separate from an adjacent bay by a rib which has holes allowing fuel to move between the adjacent bays. FIG. 11 shows two bays 51 of each wing fuel tank and a single bay 52 of the centre fuel tank. Each one of the five bays has a pair of fiberscopes installed as shown in FIG. 1. Elements 6,7,10,12,14 in FIG. 1 are collectively part of an image elaboration and elaboration section 9. In the architecture of FIG. 11 each fibre bundle leads to a single centralised image elaboration and elaboration section 9 in a pressurised and conditioned area.

FIG. 12 shows an alternative localised architecture in which three image elaboration and elaboration sections 9 are provided closer to the bays thus reducing the length of optical fibre bundle required. The elaborated data may be transferred to a central one of the sections 9 via an electrical or optical communication network 53.

Although the invention has been described above with reference to one or more preferred embodiments, it will be appreciated that various changes or modifications may be made without departing from the scope of the invention as defined in the appended claims.

1. A method of measuring a height of a fuel surface in an aircraft fuel tank, the method comprising: capturing one or more images of the fuel surface, each image including a fuel surface line where the fuel surface meets a structure; and analysing each image in order to determine a height of the fuel surface line at three or more points in the image, wherein at least one of the fuel surface lines is not straight, and an average angle of that fuel surface line is determined from the points in the image by spatial averaging.

2. The method of claim 1 wherein each image is analysed by determining a height of the fuel surface line at ten or more points in the image.

3. The method of claim 1 wherein the method comprises capturing a series of two or more images of the fuel surface over a time period, and determining an average height of the fuel surface from the series of images by time averaging.

4. The method of claim 3 wherein the time period is greater than one minute.

5. The method of claim 3 wherein the time period is less than ten seconds.

6. The method of claim 1 further comprising using the height of the fuel surface line(s) at three or more points to determine a volume of the fuel, and/or a mass of the fuel, and/or an attitude of the fuel surface.

7. The method of claim 1, wherein each image is analysed by determining a height of the fuel surface line at three or more points in the image relative to a feature in the image.

8. The method of claim 7, wherein the feature in the image is a grid line carried by the structure.

9. The method of claim 7 wherein each image is analysed by counting a number of pixels between the fuel surface line and the feature in the image.

10. The method of claim 1 wherein the image is captured by a fiberscope comprising a bundle of optical fibres.

11. The method of claim 1 further comprising applying distortion correction to the image.

12. The method of claim 1 further comprising displaying at least one of the images.

13. Apparatus for measuring a height of a fuel surface in an aircraft fuel tank, the method comprising: an image capture device arranged to capture one or more images of the fuel surface, each image including a fuel surface line where the fuel surface meets a structure; and a processor arranged to analyse each image in order to determine a height of the fuel surface line at three or more points in the image, wherein at least one of the fuel surface lines is not straight, and the processor is arranged to determine an average angle of that fuel surface line from the points in the image by spatial averaging.

14. The apparatus of claim 13 further comprising a display device arranged to receive and display at least one of the images.

15. An aircraft fuel tank system comprising a fuel tank, and apparatus according to claim 13 for measuring a height of a fuel surface in the fuel tank.

16. A system according to claim 15 wherein the fuel tank comprises a window, and the image capture device is positioned outside the fuel tank and arranged to capture the image(s) of the fuel surface through the window.

17. A system according to claim 15 wherein the fuel tank comprises a structure which carries one or more features, and wherein the processor is arranged to analyse each image by determining a height of the fuel surface line at one or more points in the image relative to one of said features in the image.
